(19) United States
(12) Patent Application Publication
(10) Pub. No.: US 2006/0214884 A1
(43) Pub. Date: Sep. 28, 2006

(54) Plasma display panel driving method and plasma display apparatus

(76) Inventors: Takashi Shiizaki, Yokohama (JP); Katsuhiro Ishida, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/386,830

(22) Filed: Mar. 23, 2006

(30) Foreign Application Priority Data
Mar. 24, 2005 (JP) JP2005-86719

(51) Int. Cl. G09G 3/28

(52) U.S. Cl. 345/60

(57) ABSTRACT

In a conventional plasma display panel driving method, all sub-frames each require a driving sequence for resetting a charge, thereby increasing a background light-emission intensity and reducing contrast. A plasma display panel driving method according to the present invention comprises the steps of: configuring one frame by a plurality of sub-frames, and setting, for each of the sub-frames, an address period for using every other one of the display electrodes as a scan electrode to cause the address discharge to occur by the scan electrode and the address electrode, and a display period for causing a surface discharge to occur between the display electrodes; and in at least two sub-frames of the plurality of sub-frames configuring one frame, causing a discharge to occur in only one of two display lines sharing one scan electrode in the address period and the display period.

### CROSS-REFERENCE TO RELATED APPLICATION

The present application claims priority from Japanese patent application No. JP 2005-086719 filed on Mar. 24, 2005 the content of which is hereby incorporated by reference into this application.

### BACKGROUND OF THE INVENTION

The present invention relates to a driving method of a plasma display panel (PDP) and a plasma display apparatus and, more particularly, to a plasma display panel driving method and a plasma display apparatus allowing a reduction in background light emission to improve contrast.

In recent years, AC plasma display apparatuses for surface discharge have been commercially available as flat-type display apparatuses, and have been used as flat-type wall-mounted televisions, display apparatuses such as personal computers or workstations, or apparatuses for displaying advertisements, information, or others. The plasma display apparatus for surface discharge has a structure in which a pair of electrodes are formed on an inner surface of a front glass substrate and an inert gas is enclosed within an interior of the substrate. When a voltage is applied between these electrodes, surface discharges occur on surfaces of a dielectric layer and a protective layer formed on an electrode surface, whereby ultraviolet radiation is generated. On an inner surface of a rear glass substrate, phosphor materials of three primary colors, red (R), green (G), and blue (B) are coated. By making these phosphor materials excited and emitted by the ultraviolet radiation, color display is achieved.

In the above PDP, a plurality of display electrodes are evenly spaced apart from one another in a column direction on a screen, and all of display lines between adjacent display electrodes become surface-dischargeable. A plurality of address electrodes intersecting with the display electrodes are disposed in a row direction on the screen, and a crossing portion of the display line and the address electrode forms a cell (unit light-emitting area).

Here, in general, in a surface-discharge type PDP, two display electrodes (X electrode and Y electrode) form an electrode pair for surface discharge. Thus, in the PDP having the above structure, the two display lines adjacent to each other share one display electrode as a scan electrode. That is, when an address discharge for selecting a cell to be turned on is caused, the odd-row display line and the even-row display line share one scan electrode. Therefore, as a display style, an interlace style is generally used. In recent years, however, progressive display is also possible (for example, see Patent Document 1: Japanese Patent Laid-Open Publication No. 2003-005699). Hereinafter, a PDP having the structure in which the display electrodes are evenly spaced apart from one another is referred to as a “PDP with Alternate Lighting of Surfaces (ALIS) structure”.

FIG. 1 is a block diagram schematically showing an entire configuration of one example of a plasma display apparatus, and is one showing the plasma display apparatus using the PDP with ALIS structure currently commercially available.

A plasma display apparatus 100 includes a PDP 10; an X-side common driver 32, a Y-side common driver 33, a Y-side scan driver 34, and an address driver 35 for driving each cell of the PDP 10; and a control circuit (logic unit) 31 for controlling each of these drivers. In the control circuit 31, input data Din that is multilevel image data indicative of luminance levels of three colors, R, G, and B, a dot clock CLK, and various synchronizing signals (a horizontal synchronizing signal Hsync, a vertical synchronizing signal Vsync, and others) are inputted from an external device such as a TV tuner or a computer; and control signals suitable for the respective drivers 32 to 35 are outputted from the above-mentioned input data Din, dot clock CLK, and various synchronizing signals to perform predetermined image display.

The control circuit 31 includes: a luminance/power control unit 311 for controlling luminance and power consumption of the PDP 10; a scan/common driver control unit 312 for controlling scanning of the Y electrode via the Y-side scan driver 34 and controlling, via the X-side common driver 32 and the Y-side common driver 33 and the like, a sustain discharge in the display electrode (between an X electrode and a Y electrode); and a display data control unit 313 for controlling, via the address driver 35, data to be displayed on the PDP 10.

FIG. 2 is a view schematically depicting a portion of a plasma display panel in the plasma display apparatus shown in FIG. 1 and shows the PDP with ALIS structure.

In FIG. 2, the reference numeral “10” denotes a plasma display panel (PDP), “11” a front-side substrate, “12” a transparent electrode, “13” a bus electrode, “17” and “24” dielectric films, “18” a protective layer, and “21” a rear-side substrate. Furthermore, the reference numerals “28R”, “28G”, and “28B” denote phosphor layers, “29” a barrier rib, “A” an address electrode, “L” a display line, and “X” and “Y” display electrodes. Herein, the PDP 10 shown in FIG. 2 is a PDP having an AC three-electrode surface-discharge structure for color display. In this structure, broadly speaking, a plurality of display electrodes are disposed between a pair of substrates, and a plurality of address electrodes are disposed in a direction of intersecting with these display electrodes.

The PDP 10 is configured by a front-side panel assembly including the front-side substrate 11 and a rear-side panel assembly including the rear-side substrate 21. The front-side substrate 11 and the rear-side substrate 21 are made of glass.

On an inner-side surface of the front-side substrate 11, a plurality of display electrodes X and Y are evenly spaced apart in parallel to each other in a column direction of the screen so that a surface discharge occurs between the adjacent electrodes. These display electrodes X and Y cause the surface discharge for display to occur between adjacent display electrode X (also called an X electrode) and display electrode Y (also called a Y electrode). Since such a surface discharge is a discharge for display, it is generally called a display discharge. Furthermore, such a surface discharge is a discharge for sustaining an On state, it is also called a sustain discharge. In this sense, the display electrodes are also called sustain electrodes.

The display electrodes X and Y are each configured by: a wide transparent electrode 12 such as ITO or SnO₂; and a narrow bus electrode 13 for reducing resistance of the electrode, for example, the narrow bus electrode being made of metal such as Ag, Au, Al, Cu, Cr, and a stacked material thereof (for example, a stacked structure of Cr/Cu/Cr). The display electrodes X and Y are each formed desirably in number, thickness, width, and interval by, for example, using a printing scheme for Ag and Au and using a combination of a film forming method, such as a vapor deposition method or spattering method, and an etching method for other metal. In addressing, the display electrode Y is used as a scan electrode.

The transparent electrode 12 for use may have a belt shape, have a wide portion corresponding only to the discharge cell, or be separated for each discharge cell and commonly connected via a bus electrode. The dielectric layer 17 is formed by, for example, using a screen printing method to apply, to the front-side substrate 11, glass paste formed by adding a binder and a solvent to a low-melting glass frit, and then firing the resultant substrate. On the dielectric layer 17, the protective film 18 is provided to protect the dielectric layer 17 from damages by ion collision occurring due to a discharge at a time of display. This protective film 18 is made of MgO, CaO, SrO, BaO, or the like, for example.

On the inner-side surface of the rear-side substrate 21, a plurality of address electrodes A (also called A electrodes) are formed in parallel to each other in a row direction of the screen so as to be perpendicular to the display electrodes X and Y. These address electrodes A cause an address discharge to occur at the crossing portions with the display electrodes for scanning, and are made of, for example, Ag, Au, Al, Cu, Cr, or a stacked material thereof (for example, stacked structure of Cr/Cu/Cr). As with the display electrodes X and Y, the address electrodes A are each formed desirably in number, thickness, width, and interval by, for example, using a printing scheme for Ag and Au and using a combination of a film forming method, such as a vapor deposition method or spattering method, and an etching method for other metal. The dielectric layer 24 is formed by using the same material and method as those for forming the dielectric layer 17.

The barrier walls 29 are each formed on the dielectric layer 24 located at a corresponding position between the address electrodes A by a sandblasting, printing, photo-etching, or other method. Specifically, the barrier ribs 29 can be formed in such a manner that glass paste made of a low-melting glass frit, a binder, a solvent, and others is coated onto the dielectric layer 24 and dried and then, for example, is cut through a sandblasting method and is fired. Also, the barrier ribs 29 may be formed by using a photosensitive resin as a binder and being fired after exposure and development using a mask.

The phosphor layers 28R, 28G, and 28B are formed by: applying phosphor paste including phosphor powder and a binder into a groove between the barrier ribs 29 by a method of using a screen printing or dispenser; and being fired after repeatedly performing the above application for each color. The phosphor layers 28R, 28G, and 28B can also be formed by using a sheet-like phosphor material including phosphor powder and a binder (so-called a green sheet) by using a photolithography method. In this case, a desired color sheet is pasted on the entire display area of the substrate and then is exposed and developed, and this process is repeatedly performed for each color, whereby the phosphor layer for each color is formed between the corresponding barrier ribs.

The PDP 10 is manufactured by: oppositely disposing the above-mentioned front-side panel assembly and rear-side panel assembly so that the display electrodes X and Y and the address electrodes A are perpendicular to one another; sealing around the assemblies; and filling each space surrounded by the barrier ribs 29 with a discharge gas such as a mixed gas of neon and xenon. In this PDP 10, a discharge space at the crossing portion between the display electrodes X and Y and the address electrode A forms one cell (unit light-emitting area), which is a minimum unit of display.

FIG. 3 is a view showing in a two-dimensional manner a portion of the plasma display panel in the plasma display apparatus shown in FIG. 1 and is a plane view of the plasma display panel with ALIS structure.

As shown in FIG. 3, as described above, in the PDP with ALIS structure, display electrodes Xn and Yn are disposed in parallel to one another in a column direction of a screen, and address electrodes A are disposed in parallel to one another in a row direction on the screen so as to be perpendicular to the display electrodes. Barrier ribs 29 are each disposed between and in parallel to the address electrodes A. The number of display electrodes disposed is the number of discharge cells in the column direction on the screen plus 1 (one), that is, “the number of display lines L”+1, whilst the number of address electrodes A disposed is the same as the number of discharge cells in the row direction on the screen.

The display lines L includes a first display line L1 between display electrodes X1 and Y1, a second display line L2 between display electrodes Y1 and X2, a third display line L3 between display electrodes X2 and Y2, a (2n−1)-th display line L2n−1 between display electrodes Xn and Yn, and a 2n−th display line L2n between display electrodes Xn and Yn+1.

FIG. 4 is an enlarged view of a portion of the plasma display panel in the plasma display apparatus shown in FIG. 1.

As shown in FIG. 4, a display discharge occurs in a space sandwiched between the two barrier ribs 29, 29 adjacent to each other, and therefore a discharge area sandwiched between the display electrodes X and Y becomes a discharge cell C.

FIGS. 5A and 5B are views for describing a gray-tone driving scheme for the plasma display apparatus. FIG. 5A depicts one frame (field) formed by eight sub-frames (subfields) SF1 to SF8, whilst FIG. 5B depicts one sub-frame (SF6) formed by a reset period TR, an address period TA, and a sustain period TS.

As shown in FIG. 5A, in a PDP for color display, one frame period for displaying moving pictures (in many cases, 1/60 second) is formed by the plurality of sub-frames SF1 to SF8 each having weighted luminance. Here, for example, the weight of the luminance of SF1: SF2: SF3: SF4: SF5: SF6: SF7: SF8 is 1: 2: 4: 8: 16: 32: 64: 128 for allowing 256 gray-scale display. Note that the number of sub-frames and the luminance weight for each sub-frame can be varied.

Each sub-frame includes: the reset period TR for equalizing wall charges of all cells in the display area; the address period TA for selecting a cell to be turned on; and the display period TS for causing the selected cell to be discharged (turned on) the number of times corresponding to the luminance of that cell. The eight sub-frames SF1 to SF8 are selectively turned on correspondingly to the luminance for display, thereby performing a display of one frame.

Here, the addressing scheme for display includes a write addressing scheme and a delete addressing scheme. In the write addressing scheme, the wall charges of all cells are deleted in the reset period TR, addressing is performed in the address period TA so as to form selectively a wall charge at the cell to be turned on, and then the procedure goes to the display period TS. In the delete addressing scheme, wall charges are formed at all cells in the reset period TR as a preparation for addressing, addressing is performed in the address period TA so that wall charges of cells not to be turned on are selectively deleted, and then the procedure goes to the display period TS.

FIG. 6 is a view for describing a driving sequence in a conventional plasma display panel driving method. FIG. 7 is a view for describing areas to which the driving sequence shown in FIG. 6 is applied. FIG. 8 is a view depicting an example of driving waveforms in the conventional plasma display panel driving method.

As shown in FIGS. 6 and 7, conventionally, for progressive driving of the above-described PDP with ALIS structure, for example, a first display area A is formed between an odd-row display electrode X (for example, X3) and the display electrodes Y adjacent to that display electrode X (for example, Y2 and Y3) (that is, in display lines L4 and L5). Concurrently, a second display area B is formed between an even-row display electrode X (for example, X4) and the display electrodes Y adjacent to that display electrode X (for example, Y3 and Y4) (that is, in display lines L6 and L7). These areas A and B are then alternately driven for progressive display. Note that, in FIG. 8, the odd-row display electrodes X (X1, X3, X5, . . . ) are represented as X1, whilst the even-row display electrodes X (X2, X4, X6, . . . ) are represented as X2. Also, all Y electrodes are represented as Y.

That is, as shown in FIGS. 6 and 8, first, in the sub-frame SF1, the area A (the display lines L1; L4, L5; L8, L9; . . . ) is subjected to charge adjustment (Adj) and addressing (Add). Next, the area B (the display lines L2, L3; L6, L7; L10, L11; . . . ) is subjected to resetting (Reset), charge adjustment (Adj), and addressing (Add). Then, both of these areas A and B are subjected to sustain discharges (Sus).

Furthermore, in other sub-frames SF2, SF3, . . . , a relation between the areas A and B is reversed for performing a similar processing. That is, for example, in the sub-frame SF2, the area B is subjected to Adj and Add, then the area A is subjected to Reset, Adj, and Add, and then both of the areas A and B are subjected to Sus.

Incidentally, conventionally, an AC plasma display panel driving method has been suggested (for example, Patent Document 2: Japanese Patent Laid-Open Publication No. 2003-157042) in which, in order to improve a contrast characteristic by reducing black luminance without causing a strong discharge in a OFF-state pixel, negative wall charges are formed on a scan electrode and a common electrode for each of the odd-row pixels in a first sustain/delete period, a write discharge is caused to occur at each of the odd-row pixels in a first scanning period, negative wall charges are formed on a scan electrode and a common electrode for each of the even-row pixels in a second sustain/delete period, and then a write discharge occurs at each of the even-row pixels in a second scanning period.

Also, conventionally, an AC plasma display panel driving method has been suggested (for example, see Patent Document 3: Japanese Patent Laid-Open Publication No. 5-313598) in which: a first subfield (sub-frame) is configured by an entire-surface write period, an entire-surface delete period, an address period, and a sustain discharge period; each of second to seventh subfields is configured by an entire-surface delete period, an address period, and a sustain discharge period; and thereby display quality is improved.

Furthermore, conventionally, a plasma display panel driving method has been suggested (for example, see Patent Document 4: Japanese Patent Laid-Open Publication No. 9-319330) in which: one or more subfields in which neither an entire write discharge nor a delete discharge is performed are set; a subfield, whose ratio in the number of times of the sustain discharges is larger than that of the subfield in which neither the entire write discharge nor the delete discharge is performed, is set immediately before the subfield in which neither the entire write discharge nor the delete discharge; and thereby the number of times of entire write discharges and that of delete discharges are reduced in an entire write/delete period in one field to improve the contrast.

Still further, conventionally, there has been suggested a technology (for example, see Patent Document 5: Japanese Patent Laid-Open Publication No. 10-003281) in which, in order to improve image quality by reducing light-emitting luminance in black display, a plasma display panel is driven by using at least two types of subfields, that is, a first type of subfield provided with a reset period for causing all pixels to be discharged and then deleting a wall charge by taking an applied voltage between row electrodes X and Y as 0 (zero), and a second type of subfield provided with a reset period for: applying an erasing pulse having voltage value and pulse width for discharging only a pixel discharged in the previous subfield; and then annihilating a wall charge by taking an applied voltage between the row electrodes X and Y as 0 (zero) after discharging only the pixel discharged in the previous subfield.

Still further, conventionally, a plasma display panel driving method has been suggested (for example, see Non-Patent Document 1: “An Advanced Progressive Driving Method for PDP with Horizontal Barrier Ribs and Common Electrodes”, H. Hirakawa et al., IDW 2001) in which: for two areas formed by even and odd rows of display electrode X and a Y electrodes, a charge adjustment discharge and an address discharge are performed onto a first area A in each sub-frame; then a delete discharge is performed onto both of first and second areas A and B; further the reset discharge and the address discharge are performed onto the second area B; and then a sustain discharge is performed onto the first and second areas A and B.

### SUMMARY OF THE INVENTION

As having been described above, conventionally, the plasma display panel driving method of performing progressive driving by using a PDP with ALIS structure has been suggested.

However, in the conventional plasma display panel driving method described with reference to FIGS. 6 to 8, for example, a driving sequence for resetting a charge is required for each of all the sub-frames SF1 to SF9. Since this reset (Reset) involves discharge light emission (reset discharge), there is a problem to be solved such that a background light-emission intensity in displaying black color is increased and the contrast is reduced.

The present invention has been made in view of the above-described problem included in the conventional technology, and an object of the present invention is to provide a plasma display panel driving method and a plasma display apparatus capable of reducing the number of times of resets to make the background light-emission intensity small and improve contrast (darkroom contrast).

According to a first aspect of the present invention, a plasma display panel driving method, in which a plasma display panel has such an electrode configuration that a plurality of display electrodes between a pair of substrates forming a discharge space and a plurality of address electrodes intersecting with the display electrodes are provided, a display line by a surface discharge is set between the display electrodes adjacent to each other, a cell is set at a crossing portion between each of the display lines and each of the address electrodes, and when an address discharge is caused to occur for selecting the cell to be turned on, one display electrode is shared as a scan electrode between two display lines adjacent to each other, and the method comprises the steps of: configuring one frame by a plurality of sub-frames, and setting, for each of the sub-frames, an address period for using every other one of the display electrodes as a scan electrode to cause the address discharge to occur by the scan electrode and the address electrode, and a display period for causing a surface discharge to occur between the display electrodes; and in at least two sub-frames of the plurality of sub-frames configuring one frame, causing a discharge to occur in only one of two display lines sharing one scan electrode in the address period and the display period, wherein the plurality of sub-frames configuring one frame include: a first sub-frame group comprising two or more sub-frames causing the discharge to occur in only one of the two display lines sharing the one scan electrode in the address period and the display period; a second sub-frame group comprising two or more sub-frames causing the discharge to occur in only the other one of the two display lines sharing the one scan electrode in the address period and the display period in; and a third sub-frame group causing the discharge to occur in both of the two display lines sharing the one scan electrode in the address period and the display period.

According to a second aspect of the present invention, a plasma display panel driving method, in which a plasma display panel has such an electrode configuration that a plurality of display electrodes between a pair of substrates forming a discharge space and a plurality of address electrodes intersecting with the display electrodes are provided, a display line by a surface discharge is set between the display electrodes adjacent to each other, a cell is set at a crossing portion between each of the display lines and each of the address electrodes, and when an address discharge is caused to occur for selecting the cell to be turned on, one display electrode is shared as a scan electrode between two display lines adjacent to each other, and the method comprises the steps of: configuring one frame by a plurality of sub-frames, and setting, for each of the sub-frames, an address period for using every other one of the display electrodes as a scan electrode to cause the address discharge to occur by the scan electrode and the address electrode, and a display period for causing a surface discharge to occur between the display electrodes, wherein the plurality of sub-frames configuring one frame include a sub-frame having an initialization period for causing discharges to occur in all the display lines, and a sub-frame having an initialization period for causing a discharge to occur only in a cell in which a discharge has been caused to occur in a display period of a previous sub-frame.

According to a third aspect of the present invention, a plasma display apparatus comprises: a plasma display panel; a driver for driving each cell of the plasma display panel; and a control circuit for controlling the driver, and is provided wherein the plasma display panel is driven by: configuring one frame by a plurality of sub-frames, and setting, for each of the sub-frames, an address period for using every other one of the display electrodes as a scan electrode to cause the address discharge to occur by the scan electrode and the address electrode, and a display period for causing a surface discharge to occur between the display electrodes; and in at least two sub-frames of the plurality of sub-frames configuring one frame, causing a discharge to occur in only one of two display lines sharing one scan electrode in the address period and the display period.

According to a fourth aspect of the present invention, a plasma display apparatus comprising: a plasma display panel; a driver for driving each cell of the plasma display panel; and a control circuit for controlling the driver, and is provided wherein the plasma display panel is driven by configuring one frame by a plurality of sub-frames, and setting, for each of the sub-frames, an address period for using every other one of the display electrodes as a scan electrode to cause the address discharge to occur by the scan electrode and the address electrode, and a display period for causing a surface discharge to occur between the display electrodes, wherein the plurality of sub-frames configuring one frame include a sub-frame having an initialization period for causing discharges to occur in all the display lines, and a sub-frame having an initialization period for causing a discharge to occur only in a cell in which a discharge has been caused to occur in a display period of a previous sub-frame.

Note that the present invention can be applied to a plasma display panel in which display electrodes are formed of sustain electrodes (X) and scan electrodes (Y) and light emission display is performed among any adjacent display electrodes.

According to the present invention, there can be provided the plasma display panel driving method and the plasma display apparatus capable of reducing the number of times of the resets to reduce the background light-emission intensity and improve the contrast.

### BRIEF DESCRIPTION OF THE DRAWINGS

FIG. 1 is a block diagram schematically showing an entire configuration of one example of a plasma display apparatus;

FIG. 2 is a view schematically depicting a portion of a plasma display panel in the plasma display apparatus shown in FIG. 1;

FIG. 3 is a view showing in a two-dimensional manner a portion of the plasma display panel in the plasma display apparatus shown in FIG. 1;

FIG. 4 is an enlarged view showing a portion of the plasma display panel in the plasma display apparatus shown in FIG. 1;

FIG. 5A is a view for describing a gray-tone driving scheme for the plasma display apparatus;

FIG. 5B is a view for describing a gray-tone driving scheme for the plasma display apparatus;

FIG. 6 is a view for describing a driving sequence in a conventional plasma display panel driving method;

FIG. 7 is a view for describing areas to which the driving sequence shown in FIG. 6 is applied;

FIG. 8 is a view depicting one example of driving waveforms in the conventional plasma display panel driving method;

FIG. 9 is a view for describing a driving sequence in a first embodiment of a plasma display panel driving method according to the present invention;

FIG. 10 is a view depicting one example of driving waveforms in the first embodiment of the plasma display panel driving method according to the present invention;

FIG. 11 is a view depicting a relation between a gray scale and an On-state pattern in a second embodiment of the plasma display panel driving method according to the present invention;

FIG. 12 is a view for describing a driving sequence in the second embodiment of the plasma display panel driving method according to the present invention;

FIG. 13 is a view depicting one example of driving waveforms in the second embodiment of the plasma display panel driving method according to the present invention;

FIG. 14 a view depicting a relation between a gray scale and an On-state pattern in a third embodiment of the plasma display panel driving method according to the present invention; and

FIG. 15 a view for describing a driving sequence in the third embodiment of the plasma display panel driving method according to the present invention.

### DESCRIPTION OF THE PREFERRED EMBODIMENTS

With reference to the accompanying drawings, embodiments of a plasma display panel driving method and a plasma display apparatus according to the present invention will be described in detail below.

### First Embodiment

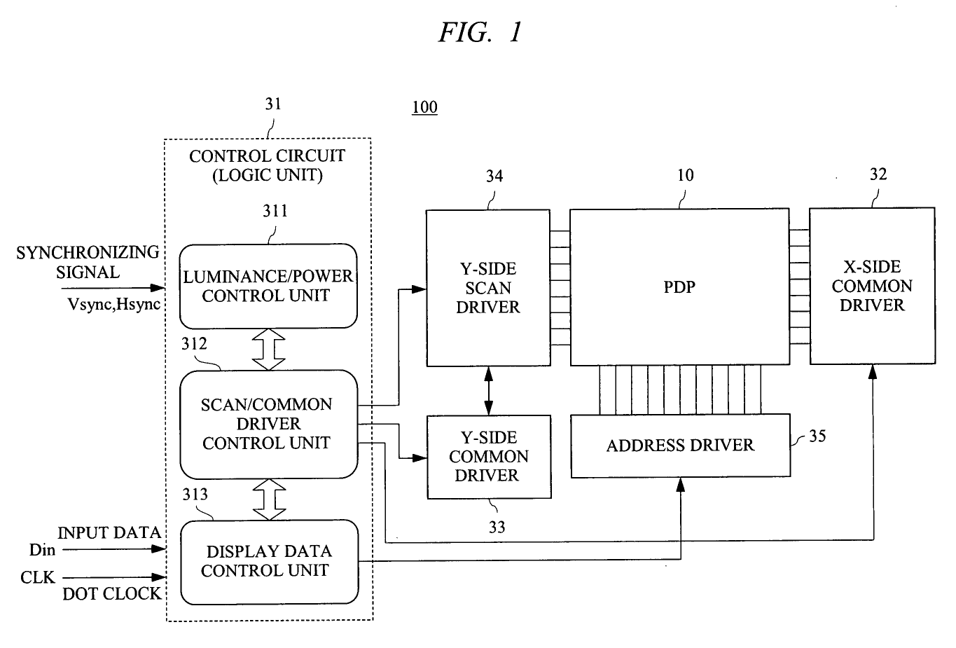

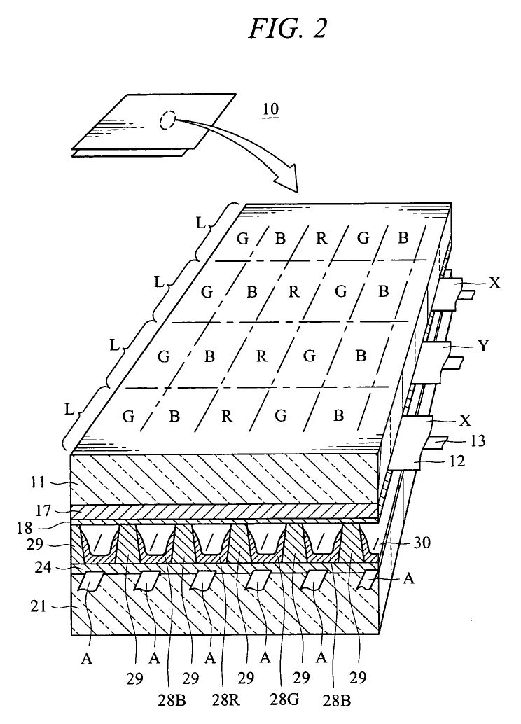

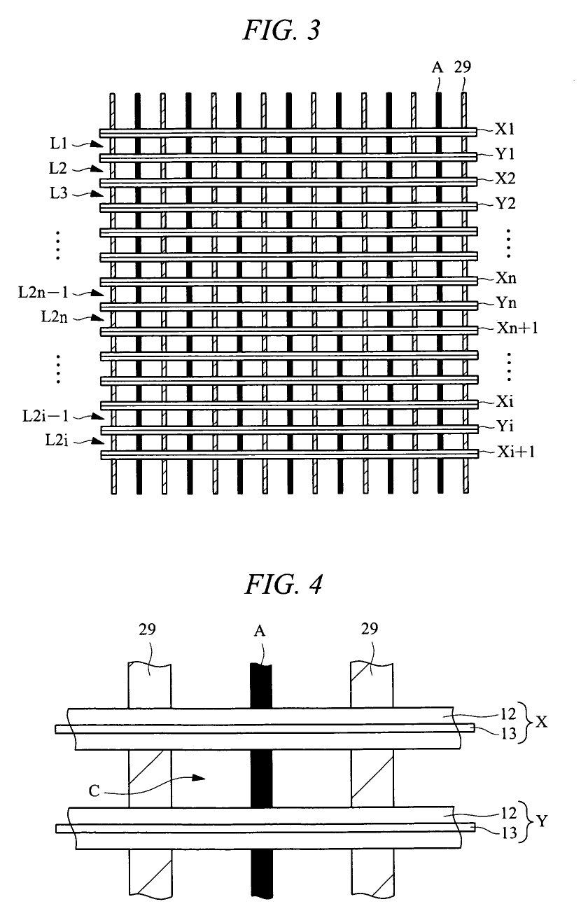

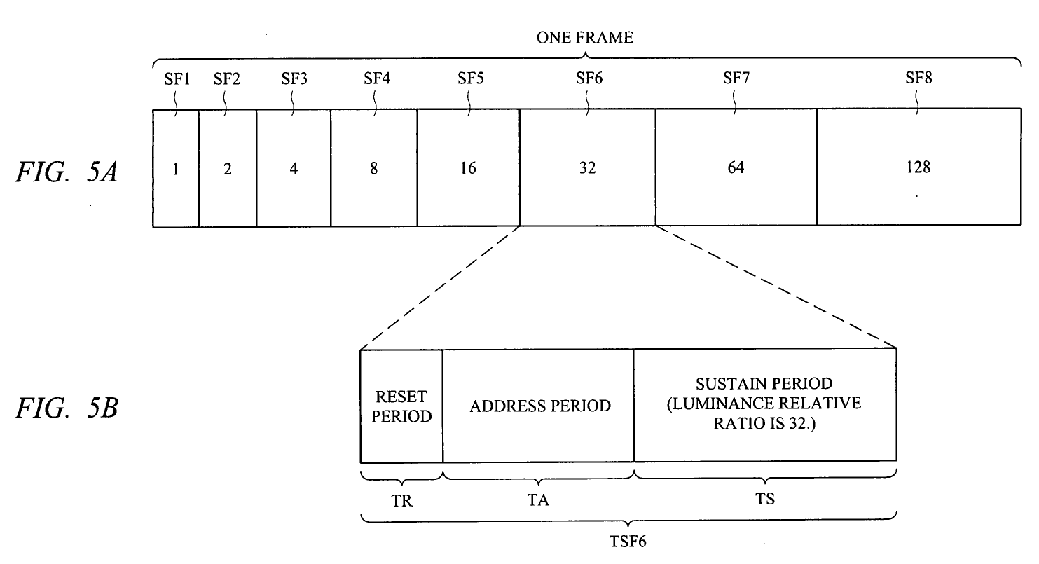

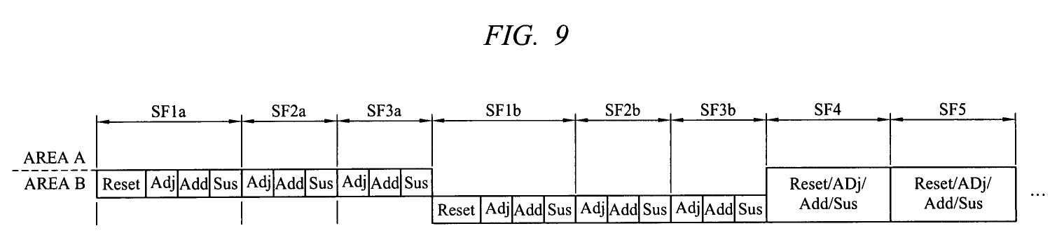

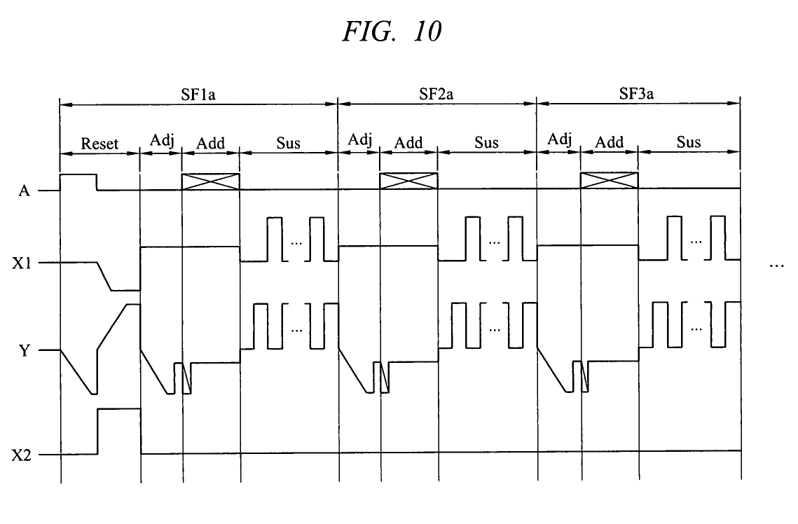

FIG. 9 is a view for describing a driving sequence in a first embodiment of a plasma display panel driving method according to the present invention. FIG. 10 is a view depicting one example of driving waveforms in the first embodiment of the plasma display panel driving method according to the present invention. Note that the plasma display panel driving method according to the present invention is applied to, for example, the plasma display apparatus described with reference to FIGS. 1 to 4.

As shown in FIG. 9, in the plasma display panel driving method according to the first embodiment, a first sub-frame SF1 to a third sub-frame SF3 are divided into SF1a to SF3a for driving an area A and SF1b to SF3b for driving an area B, respectively. Firstly, the area A is driven by the SF1a to SF3a corresponding to the first to third sub-frames SF1 to SF3, and then the area B is driven by the SF1b to SF3b corresponding to the first to third sub-frames SF1 to SF3.

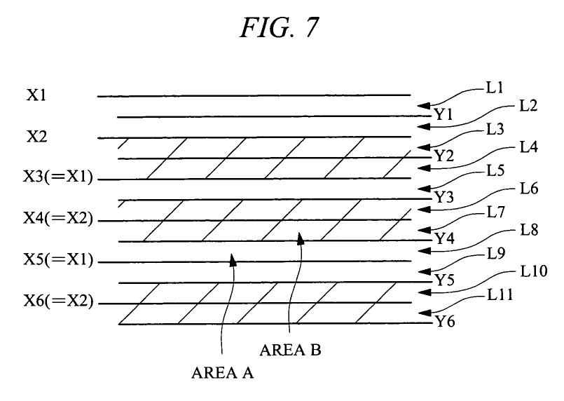

Herein, the area A is, for example, a display area formed between the odd-row display electrode X (X1) in FIG. 7 as described above and the display electrode Y adjacent to the odd-row display electrode X, that is, a display area configured by the display lines L1; L4, L5; L8, L9; . . . , whilst the area B is a display area formed between the even-row display electrode X (X2) in FIG. 7 and the display electrode Y adjacent to the even-row display electrode X, that is, a display area configured by the display lines L2, L3; L6, L7; L10, L11; . . .

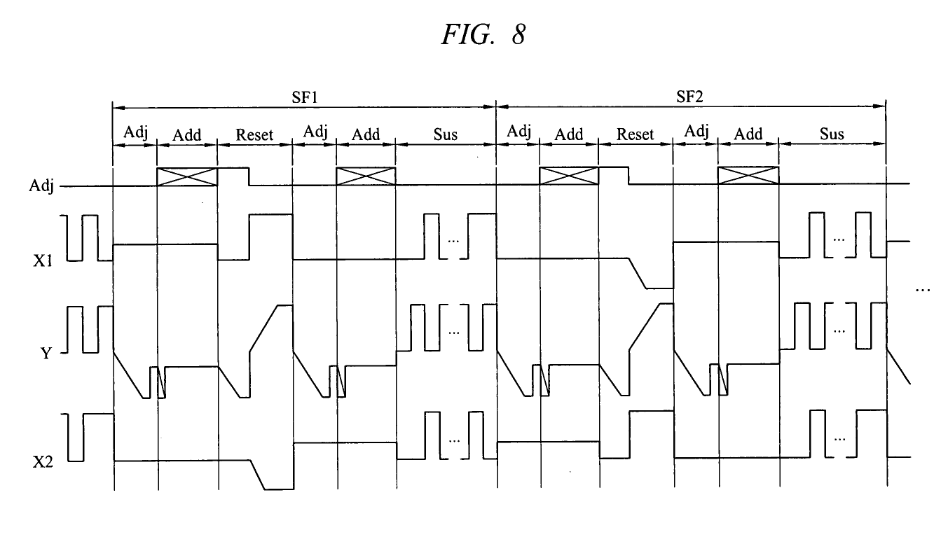

As shown in FIGS. 9 and 10, as for the driving sequence for the area A with the first to third sub-frames SF1 to SF3 (SF1a to SF3a), resetting (Reset), charge adjustment (Adj), addressing (Add), and sustain discharge (Sus) are performed in this order in the first sub-frame SF1a. However, in the next second sub-frame SF2a and third sub-frame SF3a, only Adj, Add, and Sus are performed without performing Reset. Note that in FIG. 10, as with FIG. 8 described above, the odd-row display electrodes X (X1, X3, X5, . . . ) are represented by X1, whilst the even-row display electrodes X (X2, X4, X6, . . . ) are represented by X2. Also, all the Y electrodes are represented by Y.

Furthermore, as shown in FIG. 9, as for a driving sequence for the area B with the first to third sub-frames SF1 to SF3 (SF1b to SF3b), as with the driving sequence for the area A, resetting (Reset), charge adjustment (Adj), addressing (Add), and then sustain discharge (Sus) are performed in this order in the first sub-frame SF1b. However, in the next second sub-frame SF2b and third sub-frame SF3b, only Adj, Add, and Sus are performed without performing Reset.

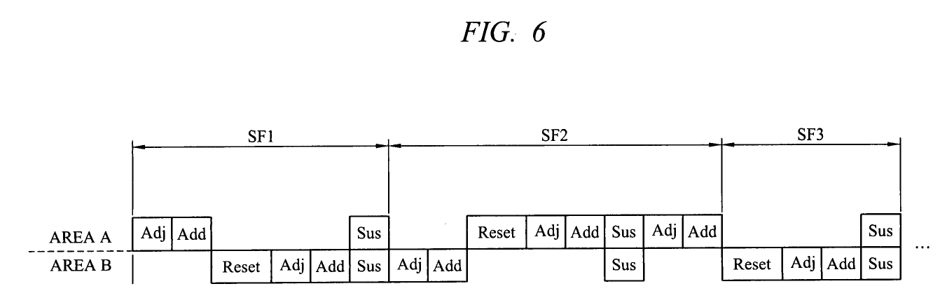

As such, according to the first embodiment, for the first to third sub-frames SF1 to SF3, for example, the number of times of Reset, which has been required to be performed three times for each sub-frame in the conventional driving method shown in FIG. 6, can be reduced to twice, once for the area A and once for the area B. That is, Reset can be omitted in SF2a, SF3a, SF2b, and SF3b.

Thereby, it is possible to reduce the background light-emission intensity due to reset discharge and improve the contrast (darkroom contrast). Also, by reducing the number of times of resetting (Reset), a driving time can be reduced. However, in the first embodiment, since the sustain discharge (Sus) cannot be performed in the areas A and B simultaneously, the time required for Sus is twice as much as that in the conventional driving method described above and shown in FIG. 6. Therefore, the first embodiment is effective when applied only to the sub-frames (for example, SF1 to SF3) having small luminance weight (a small number of sustain discharge pulses).

That is, in the first embodiment, in a fourth sub-frame SF4 and thereafter (for example, fourth to eighth sub-frames SF4 to SF8), as with the conventional driving method shown in FIG. 6, a set of Adj and Add and a set of Reset, Adj, and Add are alternately performed onto the areas A and B, and further Sus is performed onto both of the areas A and B.

Specifically, in the sub-frame SF4, Adj and Add are performed onto the area B, then Reset, Adj, and Add are performed onto the area A, and Sus is performed onto both of the areas A and B. Furthermore, in the sub-frame SF5, Adj and Add are performed onto the area A, then Reset, Adj, and Add are performed onto the area B, and Sus is performed onto both of the areas A and B.

Therefore, in the driving sequence according to the first embodiment, it is required to perform the sustain discharge (Sus) onto each of the areas A and B. Thus, driving the areas A and B with SF1a to SF3a and SF1b to SF3b is performed only for the sub-frames (for example, SF1 to SF3) having small luminance weight (a small number of sustain discharge pulses). For the sub-frames (for example, SF4 to SF8) having large luminance weight (a large number of sustain discharge pulses), the conventional driving sequence of FIG. 6, which requires Sus only once for each sub-frame, is applied.

Here, needless to say, in an actual plasma display apparatus, depending on weight setting to each sub-frame (for example, a plurality of sub-frames having small weight or the same weight are set), pulse interval/number setting of basic sustain discharge pulses, or power control setting of panels, the sub-frames to which the first embodiment is applied are not restricted to three sub-frames SF1 to SF3 and can be applied to the sub-frames SF4, SF5, and others.

### Second Embodiment

Meanwhile, as described above, resetting (Reset) is required in the conventional driving method as shown in FIGS. 6 or 8, for example. In the case of addressing the area A and then addressing the area B, for example, the scan electrode Y is shared with the areas A and B. Therefore, when the area A is addressed, a scan voltage is also applied to the area B. However, the area B has to be in a charge state in which no discharge occurs even if the scan voltage is applied. Moreover, the area B has to be in a charge state in which a discharge occurs when a scan voltage is applied in being addressed next time. For this reason, a charge control is required between the areas A and B so as to allow an address discharge in the area B. To achieve this, in the conventional driving method shown in FIGS. 6 and 8, such a charge control is performed through a reset discharge.

Here, if the previous sub-frame SF is in an On state, a charge control instead of resetting can be executed by applying a square-wave pulse between X and Y to reverse the charge. Also, at the head of the sub-frame SF, if a cell in the area B is left in a state in which positive charges are accumulated on a Y electrode side, no discharge occurs in the area B even if the area A is addressed. This is because scanning applies a negative voltage to the Y electrode side and therefore no discharge occurs if the charge on the Y electrode side is positive. Then, if the charge is reversed before addressing the area B to change the charge on the Y electrode side to negative, the area B can be addressed in the next sequence.

A second embodiment of the plasma display panel driving method according to the present invention is carried out based on the above-described viewpoint.

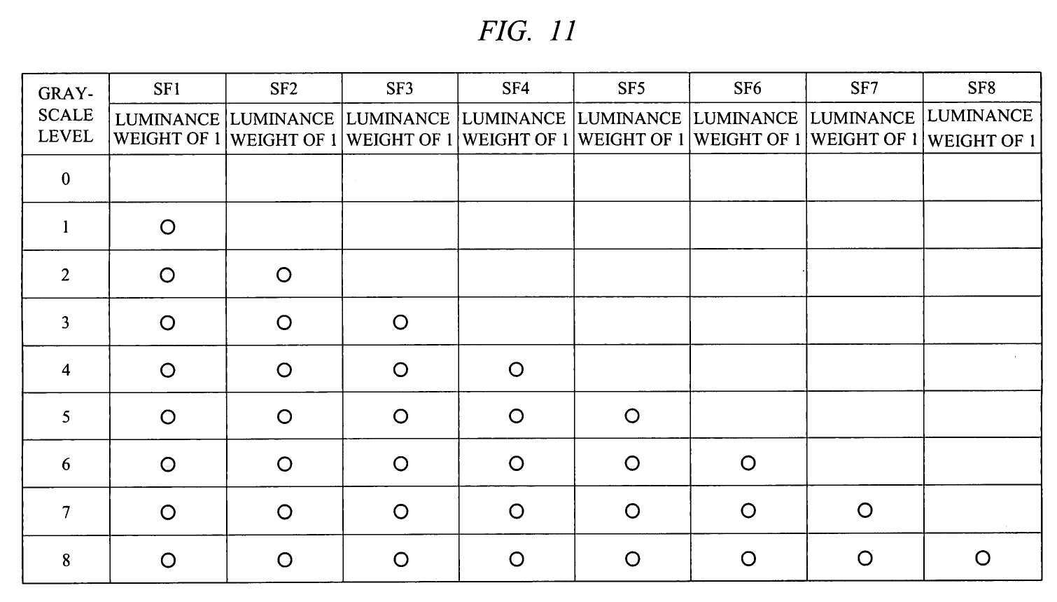

FIG. 11 is a view depicting a relation between a gray scale and an On-state pattern in the second embodiment of the plasma display panel driving method according to the present invention.

As shown in FIG. 11, in the second embodiment, gray-scale levels of 0 to 8 are represented by the sub-frames SF1 to SF8 with a luminance weight of 1, for example. Note that, in an actual plasma display apparatus, the number of gray-scale levels is increased by performing an error diffusion processing, for example.

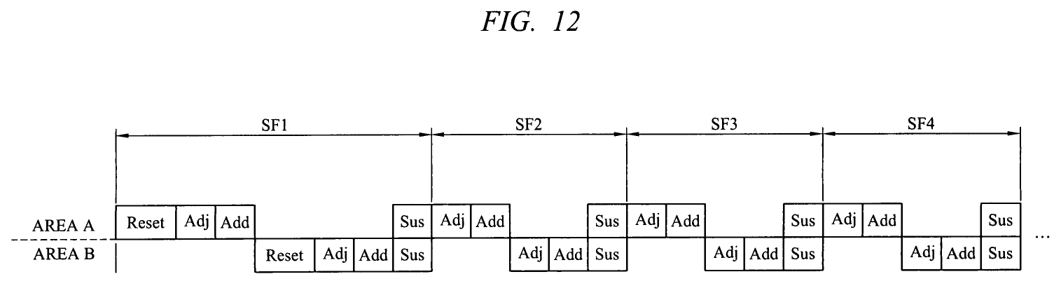

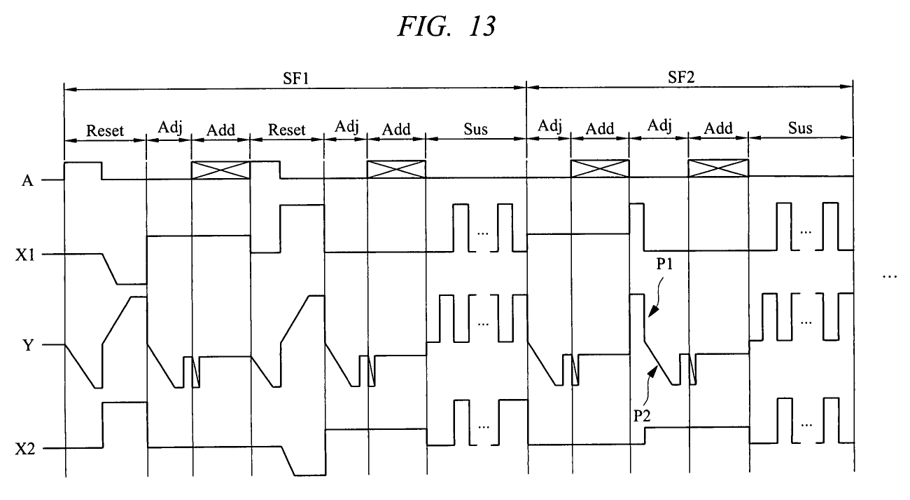

FIG. 12 is a view for describing a driving sequence in the second embodiment of the plasma display panel driving method according to the present invention. FIG. 13 is a view depicting one example of driving waveforms in the second embodiment of the plasma display panel driving method according to the present invention.

As shown in FIGS. 12 and 13, in the second embodiment, firstly, as driving for the sub-frame SF1, Reset, Adj, and Add are performed onto the area A, then Reset, Adj, and Add are performed onto the area B, and Sus is performed onto both of the areas A and B. Furthermore, as driving for the sub-frame SF2, Adj and Add are performed onto the area A, then Adj and Add are performed onto the area B, and Sus is performed onto both of the areas A and B. Similarly, as driving for each of the sub-frames SF3 to SF8, Adj and Add are performed onto the area A, then Adj and Add are performed onto the area B, and Sus is performed onto both of the areas A and B.

Here, as driving for each of the sub-frames SF2 to SF8, in each of the areas A and B, resetting (Reset) is not required. This is because, as evident from FIG. 11, in the second embodiment, when the On-state pattern for the gray scale causes an address discharge to occur in a certain sub-frame, the previous sub-frame is always being turned on.

That is, as shown in FIGS. 12 and 13, in the second embodiment, Reset is performed onto each of the areas A and B in the first sub-frame SF1. However, in the next sub-frame SF2 and thereafter, instead of resetting between the first half address and the last half address, a pulse P1 for reversing the charge and a ramp-shaped waveform P2 for charge adjustment are used.

As such, in the second embodiment, although the number of gray-scale levels cannot be increased, resetting (Reset) is required only twice for each of the areas A and B. Therefore, it is possible to reduce a background light-emission intensity due to the reset discharge, improve the contrast, and also reduce a driving time. Note that the number of gray-scale levels can be increased not only by increasing the number of sub-frames but also by performing a known error diffusion process or other processes

### Third Embodiment

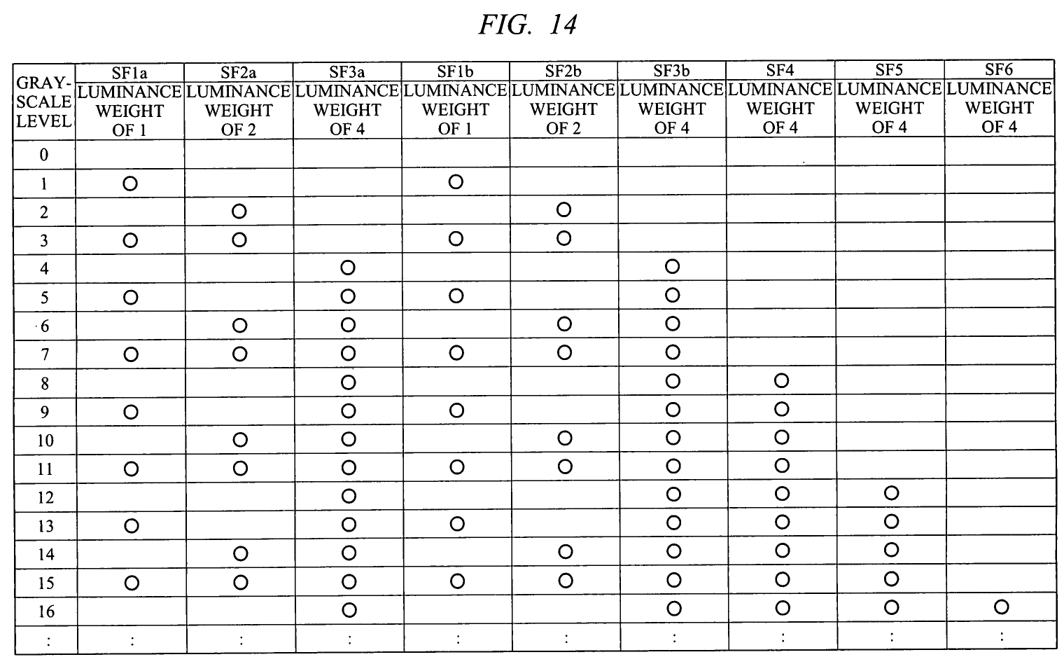

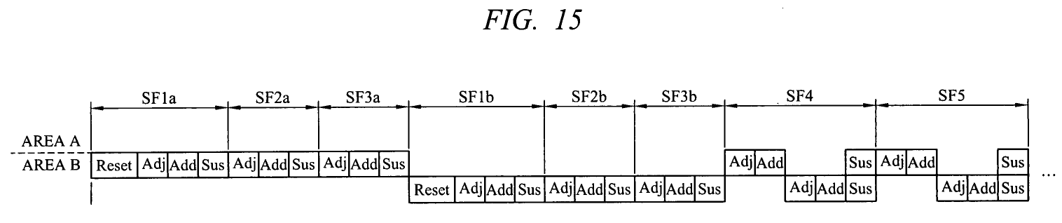

FIG. 14 is a view depicting a relation between a gray scale and an On-state pattern in a third embodiment of the plasma display panel driving method according to the present invention. FIG. 15 a view for describing a driving sequence in the third embodiment of the plasma display panel driving method according to the present invention.

In the above-described second embodiment of the present invention, there is a limitation in which the sub-frames to be turned on are successive, so that only one gray-scale level can be represented for each sub-frame, which results in a significant reduction in the number of gray-scale levels if the driving method is applied first to the sub-frames having small luminance weight. Therefore, in the third embodiment, the above-described first embodiment is applied to the sub-frames having small luminance weight (for example, the first to third sub-frames SF1 to SF3), whilst the above-described second embodiment is applied to the sub-frames having large luminance weight (for example, the fourth sub-frame SF4 and thereafter).

That is, as evident from the comparison between FIG. 15 and FIGS. 9 and 12, in the third embodiment, the sub-frames SF1a, SF1b; SF2a, SF2b; SF3a, SF3b of FIG. 9 are applied to the sub-frames SF1 to SF3, and concurrently the sub-frames SF4 and thereafter of FIG. 12 are applied to the sub-frames SF4 and thereafter (SF4 to SF6). Note that as shown in FIG. 14, the luminance weight on the sub-frames SF4 to SF6 is the same as that on the third sub-frame SF3 (SF3a and SF3b), that is, 4. At the gray-scale level of 8 and thereafter, the previous sub-frame is always being turned on.

As such, according to the third embodiment, it is possible to reduce the background light-emission intensity due to the reset discharge and improve the contrast without too much reducing the number of gray-scale levels and also to achieve a reduction in the driving time.

The present invention can be widely applied to plasma display apparatuses, such as display apparatuses for personal computers, workstations, and others, flat-type wall-mounted televisions, or apparatuses for displaying advertisements, information, and others. In particular, the present invention is widely applied to a plasma display panel driving method and a plasma display apparatus, in which a display electrode such as a plasma display panel with ALIS structure includes a sustain electrode (X) and a scan electrode (Y) and a light-emitting display is performed between every adjacent display electrodes.

What is claimed is:

1. A plasma display panel driving method, in which a plasma display panel has such an electrode configuration that a plurality of display electrodes between a pair of substrates forming a discharge space and a plurality of address electrodes intersecting with the display electrodes are provided, a display line by a surface discharge is set between the display electrodes adjacent to each other, a cell is set at a crossing portion between each of the display lines and each of the address electrodes, and when an address discharge is caused to occur for selecting the cell to be turned on, one display electrode is shared as a scan electrode between two display lines adjacent to each other, the method comprising the steps of:
configuring one frame by a plurality of sub-frames, and setting, for each of the sub-frames, an address period for using every other one of the display electrodes as a scan electrode to cause the address discharge to occur by the scan electrode and the address electrode, and a display period for causing a surface discharge to occur between the display electrodes; and
in at least two sub-frames of the plurality of sub-frames configuring one frame, causing a discharge to occur in only one of two display lines sharing one scan electrode in the address period and the display period,
wherein the plurality of sub-frames configuring one frame include: a first sub-frame group comprising two or more sub-frames causing the discharge to occur in only one of the two display lines sharing the one scan electrode in the address period and the display period; a second sub-frame group comprising two or more sub-frames causing the discharge to occur in only the other one of the two display lines sharing the one scan electrode in the address period and the display period in; and a third sub-frame group causing the discharge to occur in both of the two display lines sharing the one scan electrode in the address period and the display period.

2. The plasma display panel driving method according to claim 1,
wherein the first sub-frame group includes a sub-frame having an initialization period for causing a discharge to occur in an entirety of one of the two display lines sharing the one scan electrode, and a sub-frame having an initialization period for causing a discharge to occur only in a cell in which a discharge has been caused to occur in a display period of a previous sub-frame, and
the second sub-frame group includes a sub-frame having an initialization period for causing a discharge to occur in an entirety of the other of the two display lines sharing the one scan electrode, and a sub-frame having an initialization period for causing a discharge to occur only in a cell in which a discharge has been caused to occur in a display period of a previous sub-frame.

3. The plasma display panel driving method according to claim 2,
wherein all sub-frames in the third sub-frame group are sub-frames each including an initialization period for causing a discharge to occur only in a cell in which a discharge has been caused to occur in a display period of a previous sub-frame.

4. A plasma display panel driving method, in which a plasma display panel has such an electrode configuration that a plurality of display electrodes between a pair of substrates forming a discharge space and a plurality of address electrodes intersecting with the display electrodes are provided, a display line by a surface discharge is set between the display electrodes adjacent to each other, a cell is set at a crossing portion between each of the display lines and each of the address electrodes, and when an address discharge is caused to occur for selecting the cell to be turned on, one display electrode is shared as a scan electrode between two display lines adjacent to each other, the method comprising the steps of:
configuring one frame by a plurality of sub-frames, and setting, for each of the sub-frames, an address period for using every other one of the display electrodes as a scan electrode to cause the address discharge to occur by the scan electrode and the address electrode, and a display period for causing a surface discharge to occur between the display electrodes,
wherein the plurality of sub-frames configuring one frame include a sub-frame having an initialization period for causing discharges to occur in all the display lines, and a sub-frame having an initialization period for causing a discharge to occur only in a cell in which a discharge has been caused to occur in a display period of a previous sub-frame.

5. The plasma display panel driving method according to claim 4,
wherein the plurality of sub-frames configuring one frame include:
a first sub-frame group comprising two or more sub-frames causing a discharge to occur in only one of the two display lines sharing the one scan electrode in the address period and the display period; and
a second sub-frame group comprising two or more sub-frames causing a discharge to occur in only the other of the two display lines sharing the one scan electrode in the address period and the display period, and
each of the first and second sub-frame groups includes a sub-frame having an initialization period for causing discharges to occur in all the display lines, and a sub-frame having an initialization period for causing a discharge to occur only in a cell in which a discharge has been caused to occur in a display period of a previous sub-frame.

6. A plasma display apparatus comprising:
a plasma display panel;
a driver for driving each cell of the plasma display panel; and
a control circuit for controlling the driver,
wherein the plasma display panel driving method according to claim 1 is applied to the plasma display apparatus.

7. A plasma display apparatus comprising:
a plasma display panel;
a driver for driving each cell of the plasma display panel; and
a control circuit for controlling the driver,
wherein the plasma display panel driving method according to claim 2 is applied to the plasma display apparatus.

8. A plasma display apparatus comprising:
a plasma display panel;
a driver for driving each cell of the plasma display panel; and
a control circuit for controlling the driver,
wherein the plasma display panel driving method according to claim 3 is applied to the plasma display apparatus.

9. A plasma display apparatus comprising:
a plasma display panel;
a driver for driving each cell of the plasma display panel; and
a control circuit for controlling the driver,
wherein the plasma display panel driving method according to claim 4 is applied to the plasma display apparatus.

10. A plasma display apparatus comprising:
a plasma display panel;
a driver for driving each cell of the plasma display panel; and
a control circuit for controlling the driver,
wherein the plasma display panel driving method according to claim 5 is applied to the plasma display apparatus.
